(19) United States
(12) Patent Application Publication
(10) Pub. No.: US 2012/0277354 A1
(43) Pub. Date: Nov. 1, 2012

(54) FLAME-RETARDANT MOLDING COMPOSITIONS

(75) Inventors: Alexander König, Bruchsal (DE); Florian Garlichs, Neustadt (DE); Klaus Uske, Bad Durkheim (DE); Michael Roth, Lautertal (DE); Matthias Pfeiffer, Bohl-lggelheim (DE)

(73) Assignee: BASF SE, Ludwigshafen (DE)

(21) Appl. No.: 13/457,661

(22) Filed: Apr. 27, 2012

Related U.S. Application Data
(60) Provisional application No. 61/479,879, filed on Apr. 28, 2011.

(51) Int. Cl. C08L 77/00; C08K 5/3492

(52) U.S. Cl. 524/100

(57) ABSTRACT

Thermoplastic molding compositions, comprising
A) from 10 to 99.4% by weight of at least one thermoplastic polyamide
B) from 0.5 to 20% by weight of a melam compound
C) from 0.1 to 60% by weight of red phosphorus
F) from 0 to 60% by weight of other additives,
   where the total of the percentages by weight of A) to D) is 100%.

### CROSS-REFERENCE TO RELATED APPLICATIONS

This application claims benefit (under 35 USC 119(e)) of U.S. Provisional Application 61/479,879, filed Apr. 28, 2011, which is incorporated by reference.

### BACKGROUND OF THE INVENTION

The invention relates to thermoplastic molding compositions, comprising

A) from 10 to 99.4% by weight of at least one thermoplastic polyamide
B) from 0.5 to 20% by weight of a melam compound
C) from 0.1 to 60% by weight of red phosphorus
D) from 0 to 60% by weight of other additives,
where the total of the percentages by weight of A) to D) is 100%.

The invention further relates to the use of the inventive molding compositions for production of fibers, of foils, and of moldings, and also to the resultant moldings.

When red phosphorus is incorporated into polymer melts, industrial safety problems arise due to dusting and phosphine evolution.

DE-A 27 03 052, DE-A 196 48 503, EP-A 071 788, EP-A-176 836, and EP-A 384 232 disclose various flame-retardant PA molding compositions which comprise red phosphorus.

A new issue of the IEC 60335 standard for appliances is introducing from 2006 increased stringency of requirements in fire tests for unattended household appliances whose operating current is >0.2 A. Tests apply to all plastics parts in contact with electrical conductors having this magnitude of current. These components are generally produced via injection molding from thermoplastics. The standard prescribes that the component must pass the glow-wire test (GWT to IEC 60695-2-11) at 750° C., and total burn times greater than two seconds here lead to additional complicated measures in appliance manufacture and appliance approval. A pass in the GWT glow-wire test requires that at 750° C. the total burn time, which is a measure of flame retardancy, is <=2 seconds (abbreviated to: GWT 750<=2 s).

However, when polyamide molding compositions are used currently the materials have to comprise halogen in order to provide sufficiently reliable compliance with the “GWT 750<=2 s” requirement. However, halogen-containing compounded materials have a number of disadvantages, e.g. high density, high smoke toxicity, high smoke density, and low CTI, and it is therefore desirable to find a halogen-free alternative for these applications. Clearly, polyamide molding compositions using red phosphorus as flame retardant can be used here.

Unfortunately, these compositions exhibit only an inadequate level of reproducibility in passing the GWT 750<=2 s glow-wire test, and this is moreover also very greatly dependent on the geometry of the component.

WO2007/042446 discloses combinations of melamine compounds (in particular melamine polyphosphate) in the form of flame retardant combination for PA. The flame retardancy properties of these are not entirely satisfactory. These molding compositions can moreover be used only for a small number of color formulations, because they have a red intrinsic color.

It was therefore an object of the present invention to provide flame-retardant PA molding compositions which had improved flame retardancy, perform better in the glow-wire test, and have better colorability, and comply with the abovementioned standard. At the same time, very substantial retention of mechanical properties is intended.

Accordingly, the flame-retardant molding compositions defined at the outset have been found. Preferred molding compositions of this type and their use are given in the subclaims.

The inventive molding compositions comprise, as component A), from 10 to 99.4%, preferably from 20 to 98%, and in particular from 25 to 90% by weight, of at least one polyamide.

The polyamides of the inventive molding compositions generally have a viscosity number of from 90 to 350 ml/g, preferably from 110 to 240 ml/g, determined in a 0.5% strength by weight solution in 96% strength by weight sulfuric acid at 25° C. to ISO 307.

Semicrystalline or amorphous resins with a molecular weight (weight-average) of at least 5000, e.g. those described in the U.S. Pat. Nos. 2,071,250, 2,071,251, 2,130,523, 2,130,948, 2,241,322, 2,312,966, 2,512,606 and 3,393,210, are preferred.

Examples of these are polyamides derived from lactams having from 7 to 13 ring members, e.g. polycaprolactam, polycaprylolactam, and polylaurolactam, and also polyamides obtained via reaction of dicarboxylic acids with diamines.

Dicarboxylic acids which may be used are alkanedicarboxylic acids having from 6 to 12, in particular from 6 to 10, carbon atoms, and aromatic dicarboxylic acids. Acids which may be mentioned here merely as examples are adipic acid, azelaic acid, sebacic acid, dodecanedioic acid and terephthalic and/or isophthalic acid.

Particularly suitable diamines are alkanediamines having from 6 to 12, in particular from 6 to 8, carbon atoms, and also m-xylylenediamine (e.g. Ultramid® X17 from BASF SE, 1:1 molar ratio of MXDA to adipic acid), di(4-aminophenyl)methane, di(4-aminocyclohexyl)methane, 2,2-di(4-aminophenyl)propane, 2,2-di(4-aminocyclohexyl)propane or 1,5-diamino-2-methylpentane.

Preferred polyamides are polyhexamethyleneadipamide, polyhexamethylenesebacamide and polycaprolactam, and also nylon-6/6,6 copolyamides, in particular having a proportion of from 5 to 95% by weight of caprolactam units (e.g. Ultramid® C31 from BASF SE).

Other suitable polyamides are obtainable from w-aminoalkyl nitriles, e.g. aminocapronitrile (PA 6) and adipodinitrile with hexamethylenediamine (PA 66) via what is known as direct polymerization in the presence of water, for example as described in DE-A 10313681, EP-A 1198491 and EP 922065.

Mention may also be made of polyamides obtainable, by way of example, via condensation of 1,4-diaminobutane with adipic acid at an elevated temperature (nylon-4,6). Preparation processes for polyamides of this structure are described by way of example in EP-A 38 094, EP-A 38 582, and EP-A 39 524.

Other suitable examples are polyamides obtainable via copolymerization of two or more of the abovementioned monomers, and mixtures of two or more polyamides in any desired mixing ratio. Particular preference is given to mixtures of nylon-6,6 with other polyamides, in particular to nylon-6/6,6 copolyamides.

Other polyamides which have proven particularly advantageous are semiaromatic copolyamides, such as PA 6/6T and PA 66/6T, where the triamine content of these is less than 0.5% by weight, preferably less than 0.3% by weight (see EP-A 299 444). EP-A 19 94 075 discloses other high-temperature-resistant polyamides (PA 6T/61/MXD6).

The processes described in EP-A 129 195 and 129 196 can be used to prepare the preferred semiaromatic copolyamides with low triamine content.

The following list, which is not comprehensive, comprises the polyamides A) mentioned and other polyamides A) for the purposes of the invention, and the monomers present:

AB polymers:

| | |
|---|---|
| PA 4 | Pyrrolidone |
| PA 6 | ε-Caprolactam |
| PA 7 | Ethanolactam |
| PA 8 | Caprylolactam |
| PA 9 | 9-Aminopelargonic acid |
| PA 11 | 11-Aminoundecanoic acid |
| PA 12 | Laurolactam |

AA/BB polymers:

| | |
|---|---|
| PA 46 | Tetramethylenediamine, adipic acid |
| PA 66 | Hexamethylenediamine, adipic acid |
| PA 69 | Hexamethylenediamine, azelaic acid |
| PA 610 | Hexamethylenediamine, sebacic acid |
| PA 612 | Hexamethylenediamine, decanedicarboxylic acid |
| PA 613 | Hexamethylenediamine, undecanedicarboxylic acid |
| PA 1212 | 1,12-Dodecanediamine, decanedicarboxylic acid |
| PA 1313 | 1,13-Diaminotridecane, undecanedicarboxylic acid |
| PA 6T | Hexamethylenediamine, terephthalic acid |
| PA 9T | 1,9-Nonyldiamine/terephthalic acid |
| PA MXD6 | m-Xylylenediamine, adipic acid |

AA/BB polymers:

| | |
|---|---|
| PA 6I | Hexamethylenediamine, isophthalic acid |
| PA 6-3-T | Trimethylhexamethylenediamine, terephthalic acid |
| PA 6/6T | (see PA 6 and PA 6T) |
| PA 6/66 | (see PA 6 and PA 66) |
| PA 6/12 | (see PA 6 and PA 12) |
| PA 66/6/610 | (see PA 66, PA 6 and PA 610) |
| PA 6I/6T | (see PA 6I and PA 6T) |
| PA PACM 12 | Diaminodicyclohexylmethane, laurolactam |
| PA 6I/6T/PACM | as PA 6I/6T + diaminodicyclohexylmethane |
| PA 12/MACMI | Laurolactam, dimethyldiaminodicyclohexylmethane, |
| | isophthalic acid |
| PA 12/MACMT | Laurolactam, dimethyldiaminodicyclohexylmethane, |
| | terephthalic acid |
| PA PDA-T | Phenylenediamine, terephthalic acid |

Other monomers that can be used are cyclic diamines such as those of the general formula

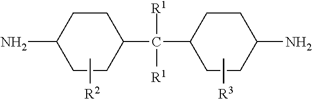

where
R¹ is hydrogen or a C₁-C₄-alkyl group,
R² is a C₁-C₄-alkyl group or hydrogen, and
R³ is a C₁-C₄-alkyl group or hydrogen.

Particularly preferred diamines are bis(4-aminocyclohexyl)methane, bis(4-amino-3-methylcyclohexyl)methane, 2,2-bis(4-aminocyclohexyl)propane, or 2,2-bis(4-amino-3-methylcyclohexyl)propane.

Other diamines which may be mentioned are 1,3- or 1,4-cyclohexanediamine or iso-phoronediamine.

It is also possible to use a mixture of above polyamides.

The inventive thermoplastic molding compositions comprise, as component B), from 0.5 to 20% by weight, preferably from 0.5 to 15% by weight, and in particular from 6 to 15% by weight, of a melam compound.

The melam compound (component B) preferably suitable in the invention is a condensate preferably obtainable from thermal treatment of melamine compounds (formula I)

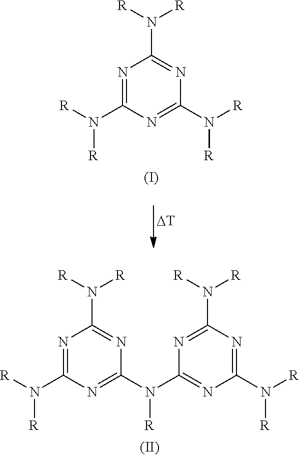

where the radicals R in (I) and (II) are mutually independently hydrogen or an alkyl radical having from 1 to 12 carbon atoms, preferably from 1 to 4 carbon atoms.

Preferred production processes can be found in WO 96/16948 or EP-A 1252168.

Preferred compound B) is melam (i.e. where all of the radicals R are therefore hydrogen), obtainable via thermal condensation of melamine (where all of the radicals R in (I)=H).

The d₅₀ particle value of melam is with particular preference from 2.24 to 4.8 μm, and its d₉₀ value is with particular preference from 13 to 14.8 μm.

Preferred flame retardant C) is elemental red phosphorus, in particular in combination with glass fiber-reinforced molding compositions; it can be used in untreated form.

However, preparations that are particularly suitable are those in which the phosphorus has been surface-coated with low-molecular-weight liquids, such as silicone oil, paraffin oil, or esters of phthalic acid or adipic acid, or with polymeric or oligomeric compounds, e.g. with phenolic resins or with aminoplastics, or else with polyurethanes.

Concentrates of red phosphorus, e.g. in a polyamide or elastomer, are also suitable as flame retardant. Particularly suitable concentrate polymers are homo- and copolyolefins. However—if no polyamide is used as thermoplastic—the content of the concentrate polymer should not be more than 35% by weight, based on the weight of components A) and B) in the inventive molding compositions.

Preferred concentrate constitutions are

C₁) from 30 to 90% by weight, preferably from 50 to 70% by weight, of a polyamide.
C₂) from 10 to 70% by weight, preferably from 30 to 50% by weight, of red phosphorus.

The polyamide used for the masterbatch can differ from A) or preferably can be identical with A), in order that incompatibility or melting-point differences do not have any adverse effect on the molding composition.

The average particle size (d₅₀) of the phosphorus particles distributed in the molding compositions is preferably in the range from 0.0001 to 0.5 mm; in particular from 0.001 to 0.2 mm.

The content of component C) in the inventive molding compositions is from 0.1 to 60% by weight, preferably from 0.5 to 40% by weight, and in particular from 2 to 10% by weight, based on the entirety of components A) to D).

The inventive molding compositions can comprise, as component D), from 0 to 60% by weight, in particular up to 50% by weight, of other additives and processing aids.

Fibrous or particulate fillers D1) that may be mentioned are carbon fibers, glass fibers, glass beads, amorphous silica, calcium silicate, calcium metasilicate, magnesium carbonate, kaolin, chalk, powdered quartz, mica, barium sulfate, and feldspar, amounts used of these being from 1 to 50% by weight, in particular from 1 to 40% by weight, preferably from 10 to 40% by weight.

Preferred compositions comprise:

A) from 20 to 97% by weight
B) from 0.5 to 15% by weight
C) from 0.5 to 40% by weight
D1) from 1 to 40% by weight
D2) from 0 to 50% by weight
where A) to D) always gives 100%.

Preferred fibrous fillers that may be mentioned are carbon fibers, aramid fibers, and potassium titanate fibers, particular preference being given here to glass fibers in the form of E glass. These can be used in the form of rovings or chopped glass or ground glass in the forms commercially available.

The fibrous fillers may have been surface-pretreated with a silane compound to improve compatibility with the thermoplastic.

Suitable silane compounds have the general formula:

(X—(CH₂)ₙ)ₖ—Si—(O—CₘH₂ₘ₊₁)₄₋ₖ

where:

### X is NH₂—,

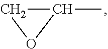

### HO—,

n is a whole number from 2 to 10, preferably 3 to 4,
m is a whole number from 1 to 5, preferably 1 to 2, and
k is a whole number from 1 to 3, preferably 1.

Preferred silane compounds are aminopropyltrimethoxysilane, aminobutyltrimethoxysilane, aminopropyltriethoxysilane and aminobutyltriethoxysilane, and also the corresponding silanes which comprise a glycidyl group as substituent X.

The amounts of the silane compounds generally used for surface coating are from 0.01 to 2% by weight, preferably from 0.025 to 1.0% by weight and in particular from 0.05 to 0.5% by weight (based on D)).

Long glass fibers are also suitable as component D1), where these can be used in the form of roving. The diameter of the glass fibers used as roving in the invention is from 6 to 20 μm, preferably from 10 to 18 μm, and the cross section of these glass fibers is round, oval, or polyhedral. In particular, E glass fibers are used in the invention. However, it is also possible to use any other type of glass fiber, examples being A, C, D, M, S, and R glass fibers, and any desired mixtures thereof, and mixtures with E glass fibers.

The L/D (length/diameter) ratio is preferably from 100 to 4000, in particular from 350 to 2000, and very particularly from 350 to 700.

Acicular mineral fillers are also suitable.

For the purposes of the invention, acicular mineral fillers are mineral fillers with strongly developed acicular character. An example is acicular wollastonite. The mineral preferably has an L/D (length to diameter) ratio of from 8:1 to 35:1, preferably from 8:1 to 11:1. The mineral filler may optionally have been pretreated with the abovementioned silane compounds, but the pretreatment is not essential.

Other fillers which may be mentioned are kaolin, calcined kaolin, wollastonite, talc and chalk, and also lamellar or acicular nanofillers, the amounts of these preferably being from 0.1 to 10%. Materials preferred for this purpose are boehmite, bentonite, montmorillonite, vermiculite, hectorite, and laponite. The lamellar nanofillers are organically modified by prior-art methods, to give them good compatibility with the organic binder. Addition of the lamellar or acicular nanofillers to the inventive nanocomposites gives a further increase in mechanical strength.

Examples of other usual additives D2) are amounts of from 1 to 30% by weight, preferably from 2 to 20% by weight, of elastomeric polymers (often also termed impact modifiers, elastomers, or rubbers).

Preferred compositions comprise:

A) from 20 to 97% by weight
B) from 0.5 to 15% by weight
C) from 0.5 to 40% by weight
D1) from 1 to 40% by weight
D2) from 1 to 30% by weight
D3) from 0 to 20% by weight
where A) to D) always gives 100%.

These are very generally copolymers which have preferably been built up from at least two of the following monomers: ethylene, propylene, butadiene, isobutene, isoprene, chloroprene, vinyl acetate, styrene, acrylonitrile and acrylates and/or methacrylates having from 1 to 18 carbon atoms in the alcohol component.

Polymers of this type are described, for example, in Houben-Weyl, Methoden der organischen Chemie, Vol. 14/1 (Georg-Thieme-Verlag, Stuttgart, Germany, 1961), pages 392-406, and in the monograph by C. B. Bucknall, “Toughened Plastics” (Applied Science Publishers, London, UK, 1977).

Some preferred types of such elastomers are described below.

Preferred types of such elastomers are those known as ethylene-propylene (EPM) and ethylene-propylene-diene (EPDM) rubbers.

EPM rubbers generally have practically no residual double bonds, whereas EPDM rubbers may have from 1 to 20 double bonds per 100 carbon atoms.

Examples which may be mentioned of diene monomers for EPDM rubbers are conjugated dienes, such as isoprene and butadiene, non-conjugated dienes having from 5 to 25 carbon atoms, such as 1,4-pentadiene, 1,4-hexadiene, 1,5-hexadiene, 2,5-dimethyl-1,5-hexadiene and 1,4-octadiene, cyclic dienes, such as cyclopentadiene, cyclohexadienes, cyclooctadienes and dicyclopentadiene, and also alkenylnorbornenes, such as 5-ethylidene-2-norbornene, 5-butylidene-2-norbornene, 2-methallyl-5-norbornene and 2-isopropenyl-5-norbornene, and tricyclodienes, such as 3-methyltricyclo[5.2.1.0^{2,6}]-3,8-decadiene, and mixtures of these. Preference is given to 1,5-hexadiene, 5-ethylidenenorbornene and dicyclopentadiene. The diene content of the EPDM rubbers is preferably from 0.5 to 50% by weight, in particular from 1 to 8% by weight, based on the total weight of the rubber.

EPM and EPDM rubbers may preferably also have been grafted with reactive carboxylic acids or with derivatives of these. Examples of these are acrylic acid, methacrylic acid and derivatives thereof, e.g. glycidyl (meth)acrylate, and also maleic anhydride.

Copolymers of ethylene with acrylic acid and/or methacrylic acid and/or with the esters of these acids are another group of preferred rubbers. The rubbers may also comprise dicarboxylic acids, such as maleic acid and fumaric acid, or derivatives of these acids, e.g. esters and anhydrides, and/or monomers comprising epoxy groups. These monomers comprising dicarboxylic acid derivatives or comprising epoxy groups are preferably incorporated into the rubber by adding to the monomer mixture monomers comprising dicarboxylic acid groups and/or epoxy groups and having the general formulae I, II, III or IV

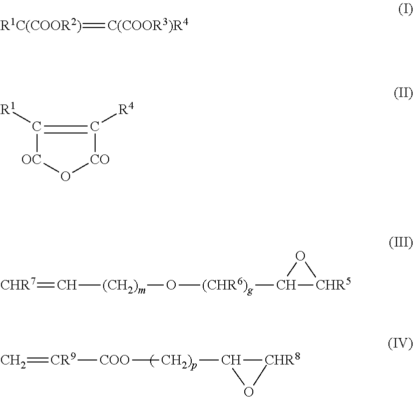

where R¹ to R⁹ are hydrogen or alkyl groups having from 1 to 6 carbon atoms, and m is a whole number from 0 to 20, g is a whole number from 0 to 10 and p is a whole number from 0 to 5.

R¹ to R⁹ are preferably hydrogen, where m is 0 or 1 and g is 1. The corresponding compounds are maleic acid, fumaric acid, maleic anhydride, allyl glycidyl ether and vinyl glycidyl ether.

Preferred compounds of the formulae I, II and IV are maleic acid, maleic anhydride and (meth)acrylates comprising epoxy groups, such as glycidyl acrylate and glycidyl methacrylate, and the esters with tertiary alcohols, such as tert-butyl acrylate. Although the latter have no free carboxy groups, their behavior approximates to that of the free acids and they are therefore termed monomers with latent carboxy groups.

The copolymers are advantageously composed of from 50 to 98% by weight of ethylene, from 0.1 to 20% by weight of monomers comprising epoxy groups and/or methacrylic acid and/or monomers comprising anhydride groups, the remaining amount being (meth)acrylates.

Particular preference is given to copolymers composed of

from 50 to 98% by weight, in particular from 55 to 95% by weight, of ethylene,
from 0.1 to 40% by weight, in particular from 0.3 to 20% by weight, of glycidyl acrylate and/or glycidyl methacrylate, (meth)acrylic acid and/or maleic anhydride, and
from 1 to 45% by weight, in particular from 5 to 40% by weight, of n-butyl acrylate and/or 2-ethylhexyl acrylate.

Other preferred (meth)acrylates are the methyl, ethyl, propyl, isobutyl and tert-butyl esters.

Besides these, comonomers which may be used are vinyl esters and vinyl ethers.

The ethylene copolymers described above may be prepared by processes known per se, preferably by random copolymerization at high pressure and elevated temperature. Appropriate processes are well-known.

Other preferred elastomers are emulsion polymers whose preparation is described, for example, by Blackley in the monograph “Emulsion Polymerization”. The emulsifiers and catalysts which can be used are known per se.

In principle it is possible to use homogeneously structured elastomers or else those with a shell structure. The shell-type structure is determined by the sequence of addition of the individual monomers. The morphology of the polymers is also affected by this sequence of addition.

Monomers which may be mentioned here, merely as examples, for the preparation of the rubber fraction of the elastomers are acrylates, such as n-butyl acrylate and 2-ethylhexyl acrylate, corresponding methacrylates, butadiene and isoprene, and also mixtures of these. These monomers may be copolymerized with other monomers, such as styrene, acrylonitrile, vinyl ethers and with other acrylates or methacrylates, such as methyl methacrylate, methyl acrylate, ethyl acrylate or propyl acrylate.

The soft or rubber phase (with a glass transition temperature of below 0° C.) of the elastomers may be the core, the outer envelope or an intermediate shell (in the case of elastomers whose structure has more than two shells). Elastomers having more than one shell may also have more than one shell composed of a rubber phase.

If one or more hard components (with glass transition temperatures above 20° C.) are involved, besides the rubber phase, in the structure of the elastomer, these are generally prepared by polymerizing, as principal monomers, styrene, acrylonitrile, methacrylonitrile, α-methylstyrene, p-methylstyrene, or acrylates or methacrylates, such as methyl acrylate, ethyl acrylate or methyl methacrylate. Besides these, it is also possible to use relatively small proportions of other comonomers.

It has proven advantageous in some cases to use emulsion polymers which have reactive groups at their surfaces. Examples of groups of this type are epoxy, carboxy, latent carboxy, amino and amide groups, and also functional groups which may be introduced by concomitant use of monomers of the general formula

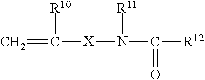

where the substituents can be defined as follows:
R¹⁰ is hydrogen or a C₁-C₄-alkyl group,
R¹¹ is hydrogen, a C₁-C₈-alkyl group or an aryl group, in particular phenyl,
R¹² is hydrogen, a C₁-C₁₀-alkyl group, a C₆-C₁₂-aryl group, or —OR¹³,
R¹³ is a C₁-C₈-alkyl group or a C₆-C₁₂-aryl group, which can optionally have substitution by groups that comprise 0 or by groups that comprise N,
X is a chemical bond, a C₁-C₁₀-alkylene group, or a C₆-C₁₂-arylene group, or

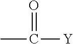

### Y is O—Z or NH—Z, and

Z is a C₁-C₁₀-alkylene or C₆-C₁₂-arylene group.

The graft monomers described in EP-A 208 187 are also suitable for introducing reactive groups at the surface.

Other examples which may be mentioned are acrylamide, methacrylamide and substituted acrylates or methacrylates, such as (N-tert-butylamino)ethyl methacrylate, (N,N-dimethylamino)ethyl acrylate, (N,N-dimethylamino)methyl acrylate and (N,N-diethylamino)ethyl acrylate.

The particles of the rubber phase may also have been crosslinked. Examples of crosslinking monomers are 1,3-butadiene, divinylbenzene, diallyl phthalate and dihydrodicyclopentadienyl acrylate, and also the compounds described in EP-A 50 265.

It is also possible to use the monomers known as graft-linking monomers, i.e. monomers having two or more polymerizable double bonds which react at different rates during the polymerization. Preference is given to the use of compounds of this type in which at least one reactive group polymerizes at about the same rate as the other monomers, while the other reactive group (or reactive groups), for example, polymerize(s) significantly more slowly. The different polymerization rates give rise to a certain proportion of unsaturated double bonds in the rubber. If another phase is then grafted onto a rubber of this type, at least some of the double bonds present in the rubber react with the graft monomers to form chemical bonds, i.e. the phase grafted on has at least some degree of chemical bonding to the graft base.

Examples of graft-linking monomers of this type are monomers comprising allyl groups, in particular allyl esters of ethylenically unsaturated carboxylic acids, for example allyl acrylate, allyl methacrylate, diallyl maleate, diallyl fumarate and diallyl itaconate, and the corresponding monoallyl compounds of these dicarboxylic acids. Besides these there is a wide variety of other suitable graft-linking monomers. For further details reference may be made here, for example, to U.S. Pat. No. 4,148,846.

The proportion of these crosslinking monomers in the impact-modifying polymer is generally up to 5% by weight, preferably not more than 3% by weight, based on the impact-modifying polymer.

Some preferred emulsion polymers are listed below. Mention may first be made here of graft polymers with a core and with at least one outer shell, and having the following structure:

| Type | Monomers for the core | Monomers for the envelope |
|---|---|---|
| I | 1,3-butadiene, isoprene, | styrene, acrylonitrile, methyl |
| | n-butyl acrylate, ethylhexyl | methacrylate |
| | acrylate, or a mixture of | |
| | these | |
| II | as I, but with concomitant use | as I |
| | of crosslinking agents | |
| III | as I or II | n-butyl acrylate, ethyl acrylate, |
| | | methyl acrylate, 1,3-butadiene, |
| | | isoprene, ethylhexyl acrylate |
| IV | as I or II | as I or III, but with concomitant |
| | | use of monomers having reactive |
| | | groups, as described herein |
| V | styrene, acrylonitrile, methyl | first envelope composed of |
| | methacrylate, or a mixture of | monomers as described under I |
| | these | and II for the core, second |
| | | envelope as described under I |
| | | or IV for the envelope |

Instead of graft polymers whose structure has more than one shell, it is also possible to use homogeneous, i.e. single-shell, elastomers composed of 1,3-butadiene, isoprene and n-butyl acrylate or of copolymers of these. These products, too, may be prepared by concomitant use of crosslinking monomers or of monomers having reactive groups.

Examples of preferred emulsion polymers are n-butyl acrylate-(meth)acrylic acid copolymers, n-butyl acrylate-glycidyl acrylate or n-butyl acrylate-glycidyl methacrylate copolymers, graft polymers with an inner core composed of n-butyl acrylate or based on butadiene and with an outer envelope composed of the abovementioned copolymers, and copolymers of ethylene with comonomers which supply reactive groups.

The elastomers described may also be prepared by other conventional processes, e.g. by suspension polymerization.

Preference is also given to silicone rubbers, as described in DE-A 37 25 576, EP-A 235 690, DE-A 38 00 603 and EP-A 319 290.

It is also possible to use mixtures of these types of rubber.

The molding compositions of the invention can comprise, as component D3), from 0.05 to 3% by weight, preferably from 0.1 to 1.5% by weight, and in particular from 0.1 to 1% by weight, of a lubricant.

Preference is given to the salts of Al, of alkali metals, or of alkaline earth metals, or esters or amides of fatty acids having from 10 to 44 carbon atoms, preferably having from 12 to 44 carbon atoms.

The metal ions are preferably alkaline earth metal and Al, particular preference being given to Ca or Mg.

Preferred metal salts are Ca stearate and Ca montanate, and also Al stearate.

Mixtures of different salts may also be used, in any desired mixing ratio.

The carboxylic acids can be monobasic or dibasic. Examples which may be mentioned are pelargonic acid, palmitic acid, lauric acid, margaric acid, dodecanedioic acid, behenic acid, and particularly preferably stearic acid, capric acid, and also montanic acid (a mixture of fatty acids having from 30 to 40 carbon atoms).

The aliphatic alcohols can be monohydric to tetrahydric. Examples of alcohols are n-butanol, n-octanol, stearyl alcohol, ethylene glycol, propylene glycol, neopentyl glycol, pentaerythritol, preference being given to glycerol and pentaerythritol.

The aliphatic amines can be mono- to tribasic. Examples of these are stearylamine, ethylenediamine, propylenediamine, hexamethylenediamine, di(6-aminohexyl)amine, particular preference being given to ethylenediamine and hexamethylenediamine. Preferred esters or amides are correspondingly glycerol distearate, glycerol tristearate, ethylenediamine distearate, glycerol monopalmitate, glycerol trilaurate, glycerol monobehenate, and pentaerythritol tetrastearate.

It is also possible to use a mixture of various esters or amides, or of esters with amides in combination, in any desired mixing ratio.

The molding compositions of the invention can comprise, as component D3), from 0.05 to 3% by weight, preferably from 0.1 to 1.5% by weight, and in particular from 0.1 to 1% by weight, of a copper stabilizer, preferably of a Cu(I) halide, in particular in a mixture with an alkali metal halide, preferably Kl, in particular in the ratio 1:4, or of a sterically hindered phenol, or a mixture of these.

Preferred salts of monovalent copper used are cuprous acetate, cuprous chloride, cuprous bromide, and cuprous iodide. The materials comprise these in amounts of from 5 to 500 ppm of copper, preferably from 10 to 250 ppm, based on polyamide.

The advantageous properties are in particular obtained if the copper is present with molecular distribution in the polyamide. This is achieved if a concentrate comprising polyamide, and comprising a salt of monovalent copper, and comprising an alkali metal halide in the form of a solid, homogeneous solution is added to the molding composition. By way of example, a typical concentrate is composed of from 79 to 95% by weight of polyamide and from 21 to 5% by weight of a mixture composed of copper iodide or copper bromide and potassium iodide. The copper concentration in the solid homogeneous solution is preferably from 0.3 to 3% by weight, in particular from 0.5 to 2% by weight, based on the total weight of the solution, and the molar ratio of cuprous iodide to potassium iodide is from 1 to 11.5, preferably from 1 to 5.

Suitable polyamides for the concentrate are homopolyamides and copolyamides, in particular nylon-6 and nylon-6,6.

Suitable sterically hindered phenols D3) are in principle all of the compounds which have a phenolic structure and which have at least one bulky group on the phenolic ring.

It is preferable to use, for example, compounds of the formula

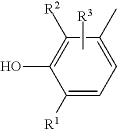

where:
R¹ and R² are an alkyl group, a substituted alkyl group, or a substituted triazole group, and where the radicals R¹ and R² may be identical or different, and R³ is an alkyl group, a substituted alkyl group, an alkoxy group, or a substituted amino group.

Antioxidants of the abovementioned type are described by way of example in DE-A 27 02 661 (U.S. Pat. No. 4,360,617).

Another group of preferred sterically hindered phenols is provided by those derived from substituted benzenecarboxylic acids, in particular from substituted benzenepropionic acids.

Particularly preferred compounds from this class are compounds of the formula

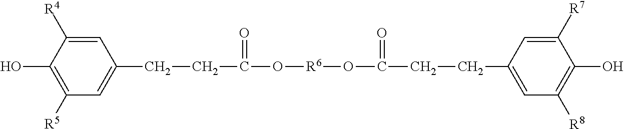

where R⁴, R⁵, R⁷, and R⁸, independently of one another, are C₁-C₈-alkyl groups which themselves may have substitution (at least one of these being a bulky group), and R⁶ is a divalent aliphatic radical which has from 1 to 10 carbon atoms and whose main chain may also have C—O bonds.

Preferred compounds corresponding to these formulae are

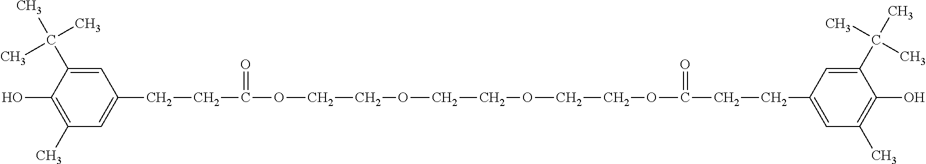

(Irganox® 245 from BASF SE)

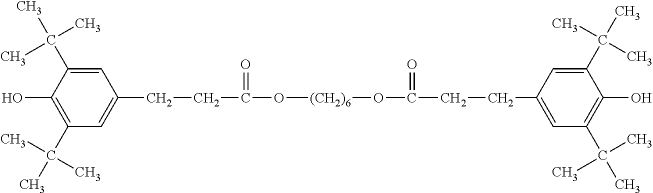

(Irganox® 259 from BASF SE)

All of the following should be mentioned as examples of sterically hindered phenols:

2,2′-methylenebis(4-methyl-6-tert-butylphenol), 1,6-hexanediol bis[3-(3,5-di-tert-butyl-4-hydroxyphenyl)propionate), pentaerythrityl tetrakis[3-(3,5-di-tert-butyl-4-hydroxy-phenol)propionate], distearyl-3,5-di-tert-butyl-4-hydroxybenzylphosphonate, 2,6,7-trioxa-1-phosphabicyclo[2.2.2]oct-4-ylmethyl 3,5-di-tert-butyl-4-hydroxyhydrocinnamate, 3,5-di-tert-butyl-4-hydroxyphenyl-3,5-distearylthiotriazylamine, 2-(2′-hydroxy-3′-hydroxy-3′,5′-di-tert-butylphenyl)-5-chlorobenzotriazole, 2,6-di-tert-butyl-4-hydroxymethylphenol, 1,3,5-trimethyl-2,4,6-tris(3,5-di-tert-butyl-4-hydroxybenzyl)benzene, 4,4′-methylenebis(2,6-di-tert-butylphenol), 3,5-di-tert-butyl-4-hydroxybenzyldimethylamine.

Compounds which have proven particularly effective and which are therefore used with preference are 2,2′-methylenebis(4-methyl-6-tert-butylphenol), 1,6-hexanediol bis(3,5-di-tert-butyl-4-hydroxyphenyl)propionate (Irganox® 259), pentaerythrityl tetrakis[3-(3,5-di-tert-butyl-4-hydroxyphenyl)propionate], and also N,N′-hexamethylenebis-3,5-di-tert-butyl-4-hydroxyhydrocinnamide (Irganox® 1098), and the product Irganox® 245 described above from Ciba Geigy, which has particularly good suitability.

The amount comprised of the antioxidants D3), which can be used individually or as a mixture, is from 0.05 up to 3% by weight, preferably from 0.1 to 1.5% by weight, in particular from 0.1 to 1% by weight, based on the total weight of the molding compositions A) to D).

In some instances, sterically hindered phenols having not more than one sterically hindered group in ortho-position with respect to the phenolic hydroxy group have proven particularly advantageous, in particular when assessing colorfastness on storage in diffuse light over prolonged periods.

The molding compositions of the invention can preferably comprise, as component D3), from 0.05 to 5% by weight, preferably from 0.1 to 2% by weight, and in particular from 0.25 to 1.5% by weight, of a nigrosin.

Nigrosins are generally a group of black or gray phenazine dyes (azine dyes) related to the indulines and taking various forms (water-soluble, oleosoluble, spirit-soluble), used in wool dyeing and wool printing, in black dyeing of silks, and in the coloring of leather, of shoe creams, of varnishes, of plastics, of stoving lacquers, of inks, and the like, and also as microscopy dyes.

Nigrosins are obtained industrially via heating of nitrobenzene, aniline, and aniline hydrochloride with metallic iron and FeCl₃.

Component D3) can be used in the form of free base or else in the form of salt (e.g. hydrochloride).

Further details concerning nigrosins can be found by way of example in the electronic encyclopedia Römpp Online, Version 2.8, Thieme-Verlag Stuttgart, 2006, key word “Nigrosin”.

The thermoplastic molding compositions of the invention may comprise, as component D3), usual processing aids, such as stabilizers, oxidation retarders, agents to counteract decomposition due to heat and decomposition due to ultraviolet light, lubricants and mold-release agents, colorants, such as dyes and pigments, nucleating agents, plasticizers, etc.

Examples which may be mentioned of oxidation retarders and heat stabilizers are sterically hindered phenols and/or phosphites and amines (e.g. TAD), hydroquinones, aromatic secondary amines, such as diphenylamines, various substituted members of these groups, and mixtures of these, and also iron powder (derived from pentacarbonyliron) in concentrations of up to 1% by weight, based on the weight of the thermoplastic molding compositions.

UV stabilizers which may be mentioned, and are generally used in amounts of up to 2% by weight, based on the molding composition, are various substituted resorcinols, salicylates, benzotriazoles, and benzophenones.

Colorants which may be added are inorganic pigments, such as titanium dioxide, ultramarine blue, iron oxide, and carbon black, and also organic pigments, such as phthalocyanines, quinacridones and perylenes, and also dyes, such as anthraquinones.

Nucleating agents which may be used are sodium phenylphosphinate, alumina, silica, and preferably talc.

The inventive thermoplastic molding compositions may be prepared by methods known per se, by mixing the starting components in conventional mixing apparatus, such as screw extruders, Brabender mixers or Banbury mixers, and then extruding them. The extrudate may then be cooled and comminuted. It is also possible to premix individual components and then to add the remaining starting materials individually and/or likewise in a mixture. The mixing temperatures are generally from 230 to 320° C.

In another preferred procedure, components B) and also optionally C) can be mixed with a prepolymer, compounded, and pelletized. The resultant pellets are then solid-phase condensed under an inert gas, continuously or batchwise, at a temperature below the melting point of component A) until the desired viscosity has been reached.

The inventive thermoplastic molding compositions feature good coloring and flame retardancy, and in particular good glow-wire test results, together with good mechanical properties.

These materials are suitable for production of fibers, foils, and moldings of any type. Some examples are now given: cylinder-head covers, motorcycle covers, intake pipes, charge-air cooler caps, plug connectors, gearwheels, cooling-fan wheels, and cooling-water tanks.

Products that can be produced with improved-flow polyamides in the electrical and electronics sector are plugs, plug parts, plug connectors, membrane switches, circuit board modules, microelectronic components, coils, I/O plug connectors, plugs for circuit boards (PCBs), plugs for flexible circuit boards (FPCs), plugs for flexible integrated circuits (FFCs), high-speed plug connections, terminal strips, connector plugs, device connectors, cable-harness components, circuit mounts, circuit-mount components, three-dimensionally injection-molded circuit mounts, electrical connection elements, and mechatronic components.

Possible automobile interior uses are those for dashboards, steering-column switches, seat components, headrests, center consoles, gearbox components and door modules, and possible automobile exterior uses are those for door handles, exterior-mirror components, windshield-wiper components, windshield-wiper protective housings, grilles, roof rails, sunroof frames, engine covers, cylinder-head covers, intake pipes (in particular inlet manifolds), windshield wipers, and exterior bodywork parts.

Possible uses of improved-flow polyamides in the kitchen and household sector are those for production of components for kitchen equipment, e.g. fryers, smoothing irons, and buttons, and also applications in the garden and leisure sectors, e.g. components for irrigation systems, or garden equipment and door handles.

### EXAMPLES

The following components were used:

### Component A):

Nylon-6,6 whose viscosity number VN is 150 ml/g, measured in the form of a 0.5% strength by weight solution in 96% strength by weight sulfuric acid at 25° C. to ISO 307 (the material used being Ultramid®A24 from BASF SE).

### Component B): Melam

Component B) was produced as in WO 96/16948

### Component B/1 C

melamine polyphosphate (Melapur® 200 from BASF SE)

### Component C)

red phosphorus

### Component D1)

glass fibers

### Component D2)

ethylene/n-butyl acrylate/acrylic acid/MA copolymer

The molding compositions were prepared in a ZSK 18 with throughput of 30 kg/h and a flat temperature profile at about 290° C.

The following tests were carried out:

MVR (275° C./5 kg load) to DIN EN ISO 1133.2005,
tensile test to ISO 527-2, and also Charpy notched impact resistance to ISO 179/1eU,
LOI value (Lowest Oxygen Index) to ISO 4589-2,
and glow-wire properties

### a) GWFi to DIN EN 60695-2-12

### b) GWiT to DIN EN 60695-2-13.

Fire protection properties were determined to UL 94 on specimens of thickness 0.8 mm.

Aging conditions: 2 days, 23° C.

Total afterflame time was determined on 5 specimens under standard conditions of temperature and humidity.

(Burning) drop performance was determined on 5 specimens under standard conditions of temperature and humidity.

The constitutions of the molding compositions and the results of the tests are given in the tables.

TABLE 1

| Components [% by weight] | Comp. 1 | 1 | 2 | 3 |
|---|---|---|---|---|
| A | 59.96 | 54.96 | 53.21 | 51.71 |
| D/1 | 26 | 26 | 26 | 26 |
| D/2 | 6 | 6 | 6 | 6 |
| C | 6.5 | 6.5 | 3.25 | 3.25 |
| B | | 5 | 10 | 10 |
| Titanium dioxide | — | — | — | 1.5 |
| MVR [cm³/10 min] | | | | |
| Modulus of elasticity [MPa] | 8242 | 8300 | 8381 | 7711 |
| Tensile stress at break | 135.2 | 136 | 137 | 109 |
| (σ_B) [MPa] | | | | |
| CTI tracking | 550 | | 600 | |
| UL 94 0.8 mm | | | | |
| Classification | V-1 | V-1 | V-0 | V-0 |
| Total afterflame time [s] | 15 | 13 | 11 | 10 |
| Ignition of cotton pad | 0 | 0 | 0 | 0 |
| 1.5 mm plaque GWIT | | | | |
| GWIT passed | <750 | <750 | 750 | 775 |
| 1.5 mm plaque GWFI | | | | |
| GWFI passed at 960° C. | yes | — | yes | yes |

All of the molding compositions comprised a total of 1.54% by weight of lubricant (calcium stearate) and stabilizers (zinc oxide, Irganox® 1098 BASF).

TABLE 2

| Components [% by weight] | Comp. 2 | Comp. 3 | Comp. 4 | Comp. 5 | Comp. 6 | Comp. 7 | Comp. 8 | Comp. 9 |
|---|---|---|---|---|---|---|---|---|
| A | 63.35 | 65 | 53.35 | 55 | 53.35 | 68 | 68 | 68 |
| D/1 | 26 | 26 | 26 | 26 | 26 | 26 | 26 | 26 |
| D/2 | 6 | 6 | 6 | 6 | 3 | 6 | 6 | 6 |
| C | 3.25 | 1.65 | 6.5 | 3.25 | 1.65 | | | |
| B/1 C | | | 10 | 10 | 10 | | 10 | 20 |
| Modulus of elasticity [MPa] | 7894 | 7909 | 9137 | 8753 | 8703 | | | |
| Tensile stress at break (σ_B) | 149 | 147 | 136.7 | 142 | 143.7 | | | |
| [MPa] | | | | | | | | |
| UL 94 0.8 mm | | | | | | | | |
| Classification | V-2 | V- | V-1 | V-1 | V-1 | V- | V- | V- |
| Total afterflame time [s] | 50 | 91 | 62 | 83 | 90 | >150 | >150 | >150 |
| Ignition of cotton pad | 1 | 9 | 0 | 0 | 0 | 0 | 0 | 0 |
| 1.5 mm plaque GWIT | | | 700 | 725 | 700 | | | |
| GWIT passed | 675 | 650 | | | | | | |
| 1.5 mm plaque GWFI | | | yes | yes | yes | | | |
| GWFI passed at 960° C. | Yes | No | 700 | 725 | 700 | | | |
| LOI (lowest oxygen index) | 25.2 | | | | | 21.6 | 27.5 | |

All of the molding compositions comprised a total of 1.54% by weight of lubricant (calcium stearate) and stabilizers (zinc oxide, Irganox ® 1098 BASF).

1-9. (canceled)

10. A thermoplastic molding composition comprising
A) from 10 to 99.4% by weight of at least one thermoplastic polyamide,
B) from 0.5 to 20% by weight of a melam compound,
C) from 0.1 to 60% by weight of red phosphorus and
D) from 0 to 60% by weight of other additives,
wherein the total of the percentages by weight of A) to D) does not exceed 100% by weight.

11. The thermoplastic molding composition according to claim 10, comprising
A) from 20 to 98% by weight of at least one thermoplastic polyamide,
B) from 0.5 to 15% by weight of a melam compound,
C) from 0.5 to 40% by weight of red phosphorus,
D1) from 1 to 40% by weight of a fibrous or particulate filler or a mixture of these and
D2) from 0 to 50% by weight of other additives.

12. The thermoplastic molding composition according to claim 10, comprising
A) from 20 to 97% by weight of at least one thermoplastic polyamide,
B) from 0.5 to 15% by weight of a melam compound,
C) from 0.5 to 40% by weight of red phosphorus,
D1) from 1 to 40% by weight of a fibrous or particulate filler or a mixture of these,
D2) from 1 to 30% by weight of an impact modifier and
D3) from 0 to 20% by weight of other additives.

13. The thermoplastic molding composition according to claim 10, wherein component C) is used in the form of a concentrate (masterbatch) in a polyamide.

14. The thermoplastic molding composition according to claim 13, wherein the constitution of the masterbatch is:
C₁) from 30 to 90% by weight of polyamide and
C₂) from 10 to 70% by weight of red phosphorus.

15. The thermoplastic molding composition according to claim 10, in which component B) is composed of compounds of the general formula 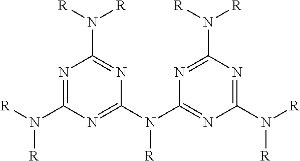
where the radicals
R are mutually independently H or an alkyl radical having from 1 to 12 carbon atoms.

16. The thermoplastic molding composition according to claim 12, wherein component C) is used in the form of a concentrate (masterbatch) in a polyamide and the constitution of the masterbatch is:
C₁) from 30 to 90% by weight of polyamide and
C₂) from 10 to 70% by weight of red phosphorus.

17. The thermoplastic molding composition according to claim 16, in which component B) is composed of compounds of the general formula 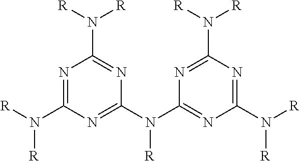
where the radicals
R are mutually independently H or an alkyl radical having from 1 to 12 carbon atoms.

18. The thermoplastic molding composition according to claim 15, wherein R are H.

19. The thermoplastic molding composition according to claim 17, wherein R are H.

20. A process for production of fibers, foils, or moldings which comprises utilizing the thermoplastic molding compositions according to claim 10.

21. A fiber, a foil, or a molding obtainable from thermoplastic molding composition according to claim 10.
